(19) United States
(12) Patent Application Publication
(10) Pub. No.: US 2009/0050717 A1
(43) Pub. Date: Feb. 26, 2009

(54) INJECTOR NOZZLE

(75) Inventor: Shigehisa Takase, Kanagawa (JP)

Correspondence Address: MCCORMICK, PAULDING & HUBER LLP, CITY PLACE II, 185 ASYLUM STREET, HARTFORD, CT, 06103, US

(73) Assignee: ISUZU MOTORS LIMITED, Tokyo (JP)

(21) Appl. No.: 12/279,885

(22) PCT Filed: Dec. 8, 2006
(86) PCT No.: PCT/JP2006/324565

§ 371 Date: Aug. 19, 2008

(30) Foreign Application Priority Data
Feb. 21, 2006 (JP) 2006-043916

(51) Int. Cl. F02M 61/10

(52) U.S. Cl. 239/533.12

(57) ABSTRACT

To provide an injector nozzle that enables the increase in the maximum injection rate of fuel. An injector nozzle 1 has a sac portion 21 for storing a fuel which is formed in a distal end portion of a nozzle body 2 and in which injection holes 11 for injecting the stored fuel are formed; and, a seat portion 22 which is formed at a proximal end side of the sac portion 21 and in which a needle valve 3 for closing the sac portion 21 can be seated. The needle 3 valve has a distal end portion which is tapered towards the distal side and which is formed by cutting off a portion located on the distal side beyond an abutment position where the seat portion can be contacted.

### CROSS REFERENCE TO RELATED APPLICATIONS

This application is entitled to the benefit of and incorporates by reference essential subject matter disclosed in International Patent Application No. PCT/JP2006/324565 filed on Dec. 8, 2006 and Japanese Patent Application No. 2006-043916 filed Feb. 21, 2006.

### TECHNICAL FIELD

The present invention relates to an injector nozzle applicable, for example, to a diesel engine using dimethyl ether as a fuel.

### BACKGROUND ART

An injector nozzle is known as an injector nozzle suitable for a diesel engine or the like (Japanese Patent Application Laid-open No. 2005-180253). The injector nozzle is configured so that a plurality of injection holes (nozzle injection holes) formed in a distal end portion thereof are opened and closed by a needle valve (referred to hereinbelow as “needle”) that is received inside the nozzle so that the needle valve can be lifted and lowered therein.

For example, as shown in FIG. 6, an injector nozzle 61 has a nozzle body 63 that receives a needle 62. The nozzle body 63 defines a sac portion 65 having a plurality of injection holes 64 formed therein and a seat portion (nozzle seat) 66 for seating the needle 62.

The injector nozzle 61 shown in FIG. 6 has a taper seat structure in which the diameter of the seat portion 66 is reduced in the downward direction.

Injector nozzles with a reduced capacity of a sac portion (for example, with a conical sac portion, a mini-sac, a VCO (Valve Covered Orifice) without a sac) have been mainly used in recent years with the object of reducing the HC amount caused by after-dropping that follows the injection of fuel. For example, in the injector nozzle 61 shown in FIG. 6, the sac portion 65 is formed in a conical shape.

In the injector nozzle 61 shown in FIG. 6, where the needle 62 is lifted, the pressurized fuel stored in a common rail (not shown in the figure) or the like flows into the sac portion 65 through a gap between the needle 62 and seat portion 66 and a gap between the needle 62 and sac portion 65 and is injected from the injection holes 64 into a combustion chamber.

However, for example, a liquefied gas fuel such as dimethyl ether (referred to hereinbelow as DME) can be also considered, in addition to the typical light oil, as a fuel to be injected by the injector nozzle 61.

When DME is used as a fuel, because the calorific power per volume of DME is less than that of the light oil, the amount of fuel that has to be injected is about twice as large as that of the light oil.

Further, by contrast with the diesel engine with light fuel injection, in the diesel engines using a DME fuel, because no C-C bonds (carbon-carbon bonds) are present, no smoke is generated, and the engine can be used at a common rail pressure within a range lower than the light oil diesel engines.

From this it follows that in order to use a DME diesel engine in the same region of engine revolution speed and load as that of the conventional light oil diesel engine and obtain the same output, it is necessary to increase the total area of the injection hole diameter and number of injection holes in the injection nozzle (that is, the total area of nozzle injection holes) with respect to that of the light oil diesel engine.

### DISCLOSURE OF THE INVENTION

However, when the total area of nozzle injection holes is increased and the sac portion capacity is decreased, the area of the flow channel between the inner wall of the sac portion 65 and the needle 62 decreases with respect to the total area of nozzle injection holes.

Thus, where the area of the flow channel between the sac portion 65 and the needle 62 becomes less than the total area of nozzle injection holes 64, the desired spraying characteristic of the injection holes cannot be obtained and the maximum injection rate is decreased.

In other words, the fuel is choked in the inlet opening of the sac portion 65, and the fuel injection rate matching the large set value of the total area of injection holes cannot be obtained.

Setting a long injection interval can be suggested to maintain the total injection amount when the maximum injection rate decreases, but in a region of high engine revolution speed, the period in which injection can be performed is short. As a result, the desired amount of fuel cannot be injected within such short injection period, thereby decreasing the output.

Accordingly, it is an object of the present invention to resolve the above-described problems and provide an injector nozzle that can increase the maximum injection rate of fuel.

In order to attain the above-described object, the present invention provides an injector nozzle comprising a sac portion for storing a fuel which is formed in a distal end portion of a nozzle body and in which injection holes for injecting the stored fuel are formed, and a seat portion which is formed at a proximal end side of the sac portion and in which a needle valve for closing the sac portion can be seated, wherein the needle valve has a distal end portion which is tapered towards the distal side and which is formed by cutting off a portion located on the distal side beyond an abutment position where the seat portion can be contacted.

Further, in order to attain the above-described object, the present invention provides an injector nozzle comprising a sac portion for storing a fuel which is formed in a distal end portion of a nozzle body and in which injection holes for injecting the stored fuel, an inner wall of the sac portion being tapered towards a distal end of the nozzle, and a seat portion which is formed at a proximal end side of the sac portion and in which a needle valve for closing the sac portion can be seated, wherein the inner wall of the sac portion defines an enlarged diameter portion opposing to the distal end portion of the needle valve.

It is preferred that the fuel be dimethyl ether.

The present invention demonstrates an excellent effect of enabling the increase in the maximum injection rate of fuel.

### BRIEF DESCRIPTION OF THE DRAWINGS

FIG. 1 is a cross-sectional view of an injector nozzle of an embodiment of the present invention.

FIG. 2 is an enlarged view of a section 11 in FIG. 1.

FIG. 3 explains the relationship between an opening area in an injector nozzle and a needle lift.

FIG. 4 is a cross-sectional view of an injector nozzle of another embodiment.

FIG. 5 is a cross-sectional view of an injector nozzle of another embodiment and a cross-sectional view of a conventional injector nozzle.

FIG. 6 is a cross-sectional view of a conventional injector nozzle.

### BEST MODE FOR CARRYING OUT THE INVENTION

A preferred embodiment of the present invention will be described below in greater detail with reference to the appended drawings.

The injector nozzle of the present embodiment is applicable, for example, to injectors of diesel engines using dimethyl ether (referred to hereinbelow as DME) as a fuel.

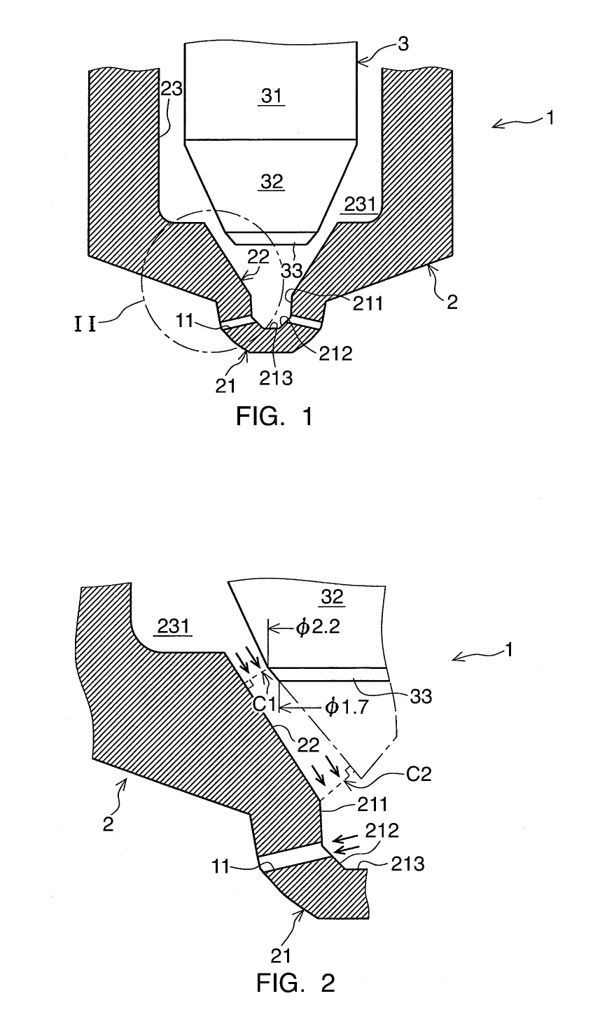

As shown in FIG. 1, an injector nozzle 1 comprises a nozzle body 2 providing with injection holes 11 for injecting a fuel and a needle valve (referred to hereinbelow as “needle”) 3 that is received inside the nozzle body 2 so that the needle valve can be lifted and lowered therein (can move in the up-down direction in FIG. 1) and serves to open and close the injection holes 11.

More specifically, the injector nozzle 1 has a sac portion 21 for storing the fuel formed in the distal end portion (lower end portion in FIG. 1) of the nozzle body 2, a seat portion 22 formed at the proximal end side (at the upper side in FIG. 1) of the sac portion 21, and an insertion bore 23 extending upwards from the seat portion 22. The injection holes 11 are formed in the sac portion 21. The needle 3 is received within the insertion bore 23 and can be seated in the seat portion 22 in order to close the sac portion 21.

The insertion bore 23 extends in the up-down direction (axial direction of the needle). The insertion bore 23 has an almost round cross section and has a diameter larger than that of the needle 3. The insertion bore 23 communicates with a common rail via a fuel supply path (not shown in the figure). A pressurized fuel from the common rail is supplied between the insertion bore 23 and the needle 3. Further, the lower portion of the insertion bore 23 defines an oil reservoir 231 that stores the pressurized fuel for pressing a pressure-receiving portion 32 of needle 3. The oil reservoir 231 is located at the outer side in the radial direction of the lower portion of the insertion bore 23.

The seat portion 22 constitutes an inner wall surface of the nozzle body 2. The seat portion 22 has a diameter less than that of the insertion bore 23 and is formed in a tapered shape which extends downwardly from the insertion bore 23. In the example shown in the figure, the seat portion 22 is formed in a shape of a funnel. The intermediate portion of the seat portion 22 in the up-down direction has a diameter almost equal to a diameter of a seat abutment portion 33 of the needle 3. The intermediate portion engages with the seat abutment portion 33 of the needle 3 when the needle 3 is seated.

More specifically, when the needle 3 is lifted, a gap is formed between the seat abutment portion 33 of the needle 3 and the seat portion 22 and the gap constitutes a fuel flow channel. In the present embodiment, the minimum flow channel area of this flow channel is set larger than the opening area of the injection hole 11. In the example shown in the figure, the diameter in a position of a perpendicular dropped from the upper end of the seat abutment portion 33 of the needle 3 onto the inner wall surface of the seat portion 22 at a maximum lift is set to 2.2 mm (see reference symbol C1 in FIG. 2). Further, the diameter of the lower end of the seat abutment portion 33 is set to 1.7 mm.

The sac portion 21 has a first tapered surface 211 extending downwardly from the seat portion 22, a second tapered surface 212 extending downwardly from the first tapered surface 211, and a bottom surface 213 connected to the lower end of the second tapered surface 212. The first tapered surface 211 is tapered downwardly at an angle smaller than that of the seat portion 22. The second tapered surface 212 is tapered downwardly at an angle larger than that of the first tapered surface 211.

A plurality of injection holes 11 are formed in the inner wall surface of the sac portion 21. In the present embodiment, these injection holes 11 are arranged along the circumferential direction and spaced predetermined intervals. The number and diameter of these injection holes 11 are adequately set according to the fuel to be injected, or the like. In the example shown in the figure, the number and diameter of the injection holes 11 are set so that the total opening area (referred to hereinbelow as “injection hole area”) of the injection holes is 0.67 mm². In the present embodiment, the injection holes 11 are disposed on the boundary of the first tapered surface 211 and the second tapered surface 212.

The needle 3 has a proximal portion 31 of a cylindrical columnar shape, the pressure-receiving portion 32 extending and tapered downwardly from the lower end of the proximal portion 31, and the seat abutment portion 33 extending downwardly from the lower end of the pressure-receiving portion 32. The seat abutment portion 33 abuts against the seat portion 22 when the needle is seated.

The seat abutment portion 33 is tapered downwardly at an angle larger than that of the pressure-receiving portion 32. In the present embodiment, the width (in the figure, the length in the up-down direction) of the seat abutment portion 33 is assumed as a width of a contact surface with the seat portion 22.

Thus, in the present embodiment, the distal end portion of the needle 3 is formed as a two-stage tapered surface (pressure-receiving portion 32 and seat abutment portion 33) that is reduced in diameter towards the distal side, and a portion of the tapered distal end portion, which is closer to the distal side of the needle 3 than the boundary of the distal side in the abutment position with the seat portion 22, is cut off.

The operation of the injector nozzle 1 of the present embodiment will be explained below.

When the injector is closed, the needle 3 is seated in the seat portion 22, and the sac portion 21 is closed from above by the needle 3. In this case, no fuel is supplied to the sac portion 21, and no fuel is injected from the injection holes 11.

As shown in FIG. 2, when the injector is opened, the needle 3 is lifted (moves upwards, as shown in FIG. 2) by an actuator (not shown in the figure) or the like.

Because of such lift of the needle 3, a gap is formed between the needle 3 and the seat portion 22. The fuel located in the insertion bore 23 is supplied into the sac portion 21 through this gap, and the fuel supplied into the sac portion 21 is injected from the injection holes 11 into a combustion chamber.

In the present embodiment, the needle 3 is formed by cutting off a portion located on the distal side beyond an abutment position where the seat portion 22 can be contacted. As a result, the fuel flows into the sac portion 21, without being choked in the inlet port of the sac portion 21. Furthermore, the diameter and taper of the seat portion 22 are set so that a minimum cross section area (minimum flow channel area) of the gap formed between the needle 3 and the seat portion 22 when the needle 3 is lifted is larger than the total area of the injection holes 11. Therefore, the fuel is not throttled in the fuel flow channel from the common rail to the injection holes 11.

Thus, in the present embodiment, by placing the distal end portion of the needle 3 as far as possible from the inner wall surface of the sac portion 21 and ensuring the flow channel area, it is possible to prevent a pressure loss of the fuel following from the common rail to injection holes 11. As a result, by setting a large injection hole area, it is possible to raise the maximum injection rate of fuel.

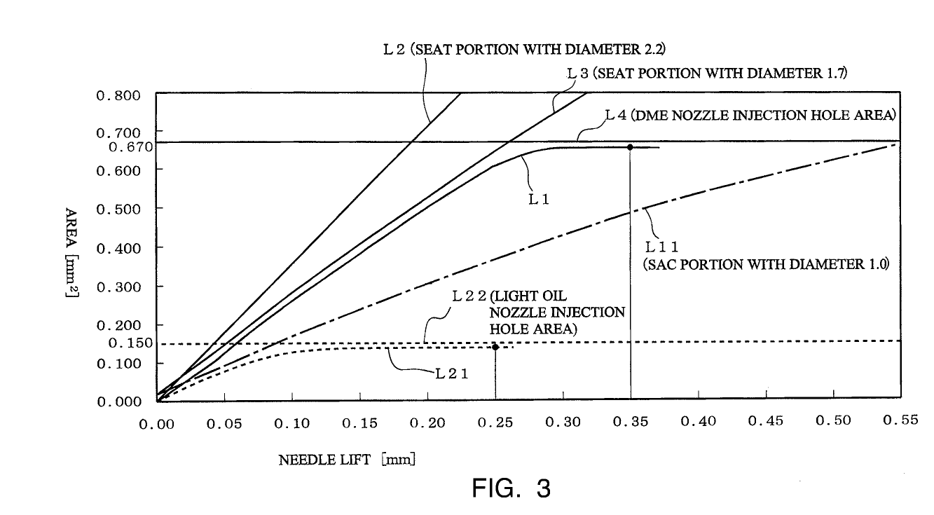

The relationship between an opening area (flow channel area) in the injector nozzle 1 and a lift (lift amount) of the needle 3 will be explained below with reference to FIG. 3.

In FIG. 3, a line L1 indicates a relationship between a minimum opening area of the fuel flow channel in the injector nozzle 1 of the present embodiment and a needle lift. A line L2 indicates the relationship between an opening area in a position with a diameter of 2.2 mm in the seat portion 22 and a needle lift. A line L3 indicates a relationship between an opening area in a position with a diameter of 1.7 mm in the seat portion 22 and a needle lift. A line L4 indicates an injection hole area (0.67 mm²) of the injection holes 11.

A line L11 indicates a relationship between an opening area at the upper end (diameter 1.0 mm) of the sac portion 65 and a needle lift in the case a conventional needle 62 shown in FIG. 6 is used.

A line L21 indicates a relationship between a minimum opening area of a fuel flow channel in a light oil nozzle (sac diameter 1.0 mm, seat diameter 1.8 mm, injection hole area 0.15 mm²) and a needle lift. A line L22 indicates an injection hole area (0.15 mm²) in the light oil nozzle.

As shown by line L1 in FIG. 3, the minimum opening area of the fuel flow channel increases with the increase in the needle lift, approaches the injection hole area, and converges thereupon, becoming almost equal to the injection hole area. The needle lift at the time of such convergence of the minimum opening area is a needle lift (referred to hereinbelow as “necessary needle lift”) necessary for injecting the fuel through the injection hole area (that is, to obtain the maximum injection rate).

For example, in the light oil nozzle L21, the necessary needle lift is about 0.25 mm.

In the present embodiment, the injection hole area L4 of a DME nozzle reaches 0.67 mm², but where the seat diameter is enlarged and the distal end of the needle 3 is formed in a shape of a frusto-cone to increase the flow channel area in the sac portion 21, the portion L3 with a diameter of 1.7 mm of the seat portion 22 has a minimum opening area (see reference symbol C1 in FIG. 2) and the necessary needle lift becomes about 0.35 mm, as shown in FIG. 2.

By contrast, in the case of a conventional injector nozzle 61 (see FIG. 6), the inlet port of the sac portion 65 has a minimum flow channel area L11 (see reference symbol C2 in FIG. 2). Therefore, where the estimation is performed by the line L11 shown in FIG. 3, the necessary needle lift becomes 0.55 mm or more. Therefore, in the conventional nozzle 61, the responsiveness (if the needle speed determined by the common rail pressure is taken as constant) of the needle 62 is degraded, the control chamber capacity increases, and the responsiveness of the injector is degraded. Further, when the needle lift is made 0.55 mm or less, the effective utilization is impossible, even if a large injection hole area is set.

As described hereinabove, in the present embodiment, the flow channel area between the inner wall surface of the sac portion 21 and the needle 3 is expanded following the increase in the nozzle injection hole area in the DME injector nozzle 1, and the predetermined injection hole area of the nozzle can be utilized effectively.

Further, although the injection hole area is increased, the necessary needle lift can be inhibited to a level below that in the conventional nozzle. Therefore, the degradation of responsiveness can be prevented.

In addition, in the present embodiment, because the needle 3 can be formed by simple processing, that is, by cutting the distal end thereof, the processing cost can be reduced and the process can be simplified. In addition, precision control can be easily performed.

The sac volume is increased by the cut-out portion at the distal end of the needle, but comparing the number of carbon atoms per molecule in light oil and DME, the light oil has about 14 to 16 carbon atoms per molecule, whereas DME has a much smaller number (two) carbon atoms per molecule. Therefore, even if dropping occurs by DME accumulated in the sac portion 21 after the injection is completed and the needle has been closed, the influence of the accumulated DME on the HC release in the exhaust gas is small.

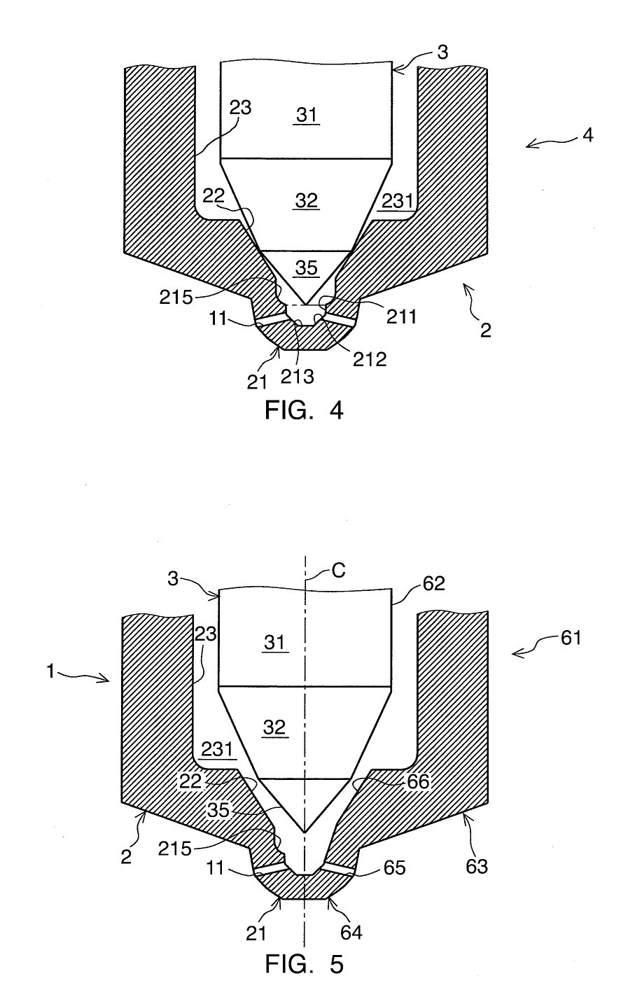

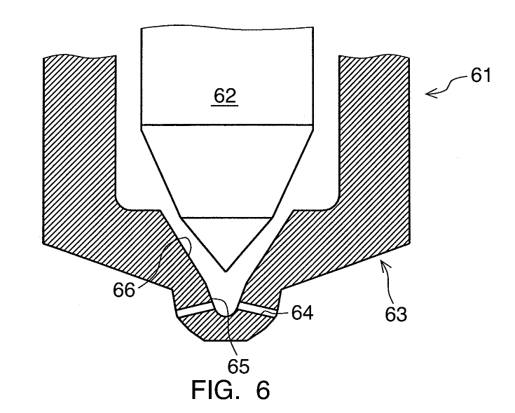

Another embodiment will be described below with reference to FIG. 4 and FIG. 5.

In the present embodiment, the shapes of the needle and sac portion differ from those of the above-described embodiment illustrated by FIG. 1, while other features of the two embodiments are identical. Accordingly, elements identical to those of the above-described embodiment are assigned with identical reference symbols and detailed explanation thereof is omitted.

In FIG. 5, an injector nozzle is divided into a left portion and a right portion by a central line C, the left portion being that of an injector nozzle 4 of the present embodiment and the right portion being that of a conventional injector nozzle 61.

In the present embodiment, an enlarged diameter portion 215 is defined in the sac portion 21 to increase an area of a flow channel formed between the sac portion 21 and a needle 3, whereby a minimum flow channel area of a fuel flow channel from the insertion bore 23 to injection holes 11 is set larger than the injection hole area.

More specifically, the injector nozzle 4 of the present embodiment comprises the sac portion 21 formed in the distal end portion of the nozzle body 2 and the seat portion 22 formed at the proximal end side of the sac portion 21. The sac portion 21 can store the fuel and has the injection holes 11 for injecting the fuel stored therein. In The seat portion 22 the needle valve 3 serving to close the sac portion 21 can be seated.

The needle 3 has the proximal portion 31, the pressure-receiving portion 32, and a seat abutment portion 35. The seat abutment portion 35 extends downwardly from the lower end of the pressure-receiving portion 32 and is formed in a conical shape facing downwardly. In the present embodiment, when the needle is seated, only the upper end portion of the seat abutment portion 35 abuts against the seat portion 22.

In the sac portion 21, the inner wall thereof is formed in a tapered shape (in the example shown in the figure, a two-stage tapered shape) that is reduced in diameter towards the distal side, and in the present embodiment, the enlarged diameter portion 215 is formed in the inner wall of the sac portion 21 facing the distal end portion of the needle 3.

The enlarged diameter portion 215 has a round cross section and extends downwardly a predetermined length from the seat portion 22. In the example shown in the figure, the enlarged diameter portion 215 extends from the lower end of the seat portion 22 to the position where the distal end of the needle 3 being seated is reached. The inner diameter of the enlarged diameter portion 215 is so set that the minimum area of the flow channel between the needle 3 and the enlarged diameter portion 215 when the needle is lifted becomes larger than the injection hole area. Further, the minimum area of the flow channel between the needle 3 and the seat portion 22 is also set larger than the injection hole area.

The lower end portion of the inner wall surface of the enlarged diameter portion 215 is rounded radially inward and formed in an R shape. The R shape is formed by processing, for example, with a ball end.

The effect obtained in the present embodiment is identical to that obtained in the above-described embodiment illustrated by FIG. 1.

The present invention is not limited to the above-described embodiments, and a variety of modification examples or application examples thereof can be considered.

For example, the fuel is not limited to DME, and a variety of liquid fuels such as light oil and gasoline can be considered.

Further, in the above-described embodiment, the enlarged diameter portion 215 of a round cross-sectional shape is provided, but such shape is not limiting, and it is also possible to provide, for example, a groove-like enlarged diameter portion by forming a recess in the inner wall surface of the sac portion 21 in a position in the circumferential direction that corresponds to injection holes 11.

While the present invention has been illustrated and described with respect to a particular embodiment thereof, it should be appreciated by those of ordinary skill in the art that various modifications to this invention may be made without departing from the spirit and scope of the present invention.

What is claimed is:

1. An injector nozzle comprising:
a sac portion for storing a fuel which is formed in a distal end portion of a nozzle body and in which injection holes for injecting the stored fuel are formed, and
a seat portion which is formed at a proximal end side of the sac portion and in which a needle valve for closing the sac portion can be seated, wherein
the needle valve has a distal end portion which is tapered towards the distal side and which is formed by cutting off a portion located on the distal side beyond an abutment position where the seat portion can be contacted.

2. An injector nozzle comprising:
a sac portion for storing a fuel which is formed in a distal end portion of a nozzle body and in which injection holes for injecting the stored fuel, an inner wall of the sac portion being tapered towards a distal end of the nozzle, and
a seat portion which is formed at a proximal end side of the sac portion and in which a needle valve for closing the sac portion can be seated, wherein
the inner wall of the sac portion defines an enlarged diameter portion opposing to the distal end portion of the needle valve.

3. The injector nozzle according to claim 1, wherein the fuel is dimethyl ether.

4. The injector nozzle according to claim 2, wherein the fuel is dimethyl ether.
